(19) United States
(12) Patent Application Publication
(10) Pub. No.: US 2020/0311406 A1
(43) Pub. Date: Oct. 1, 2020

(54) METHOD FOR ANALYSING DIGITAL DOCUMENTS

(71) Applicant: ERRE QUADRO S.R.L., 56121 PISA (IT)

(72) Inventors: Giacomo TAZZINI, MASSA (IT); Andrea CAPPALUNGA, MASSA (IT); Gualtiero FANTONI, PISA (IT); Riccardo APREDA, PISA (IT); Tommaso PAVANELLO, PECCIOLI (IT); Donata GABELLONI, MASSA (IT)

(21) Appl. No.: 16/646,015

(22) PCT Filed: Sep. 10, 2018
(86) PCT No.: PCT/IB2018/056870

§ 371 Date: Mar. 10, 2020

(30) Foreign Application Priority Data
Sep. 11, 2017 (IT) 102017000101360

(51) Int. Cl. G06K 9/00; G06F 40/197; G06F 40/117; G06F 40/169; G06F 40/247

(52) U.S. Cl. CPC G06K 9/00442; G06F 40/197; G06F 40/247; G06F 40/169; G06F 40/117

(57) ABSTRACT

Described is a method for analysing documents which can be implemented by a computer comprising the steps of:—selecting a digital document (10) comprising a text component (11) and a graphical component (12);—analysing the graphical component (12) identifying alphanumeric indicators (13) associated with respective portions of the graphical component (12);—searching inside the text component (11) of the digital document (10) for the alphanumeric indicators (13) identified inside the graphical component (12) and associating them uniquely with a text indicator (14) of the text component (11) representing the respective portions of the graphical component (12);—converting the digital document (10) into an augmented reality document (20) at least by displaying on the graphical component (12) of a corresponding text (15) of the text indicator (14), at the respective alphanumeric indicator (13) associated with the text indicator (14).

### TECHNICAL FIELD

This invention relates to the technical sector for the study and search of digital documents by computer.

More specifically, the invention relates to a method for the analysis of digital documents, especially documents of a patent type or other documents, such as, for example specifications, maintenance and user manuals, technical drawings and others, comprising, inside them, a graphical component.

The increasing development of the electronics and information sectors has lead to an ever greater digitalisation of the sources of information available to the public.

However, the quantity of information available and the amount of documents which can be consulted has made it necessary to develop special data banks and search programs which allow the information to be collected, catalogued and classified in such a way as to render it effectively and efficiently useable.

### BACKGROUND ART

There are a wide range of solutions in the computer program sector which allow access to suitable data banks, some generic and others specifically for particular sectors, and searching inside them for the desired information by using keywords or other criteria.

However, the prior art search and analysis methods are not particularly efficient in the management and presentation of documents which simultaneously have a text component and a graphical component, both from the point of view of the search between documents and within the same document.

This failing is particularly felt in the patents sector, where there is often the need to be able to associate the information contained in the graphical component, such as drawings and diagrams, with that contained in the text component, which describe in detail these elements and their constituent parts.

### SUMMARY OF THE INVENTION

In this context, the technical purpose which forms the basis of this invention is to provide a method for analysing documents which overcomes at least some of the above-mentioned drawbacks of the prior art.

More specifically, the aim of this invention is to provide a method for analysing documents which is able to manage and have a wide range of information in a dynamic, simple and efficient manner, also allowing a user to personalise it depending on the particular requirements.

The technical purpose indicated and the aims specified are substantially achieved by a method for analysing documents comprising the technical features described in one or more of the appended claims.

The invention describes a method for analysing documents which can be implemented by a computer comprising the steps of:
selecting a digital document comprising a text component and a graphical component;
analysing the graphical component identifying alphanumeric indicators associated with respective portions of the graphical component;
searching inside the text component of the digital document for the alphanumeric indicators identified inside the graphical component and associating them uniquely with a text indicator of the text component representing the respective portions of the graphical component;
converting the digital document into an augmented reality document configured for displaying on the graphical component a corresponding text of the text indicator, at the respective alphanumeric indicator associated with the text indicator.

### DESCRIPTION OF THE DRAWINGS

Further features and advantages of this invention are more apparent in the detailed description below, with reference to a preferred, non-restricting, embodiment of a method for analysing documents as illustrated in the accompanying drawings, in which:

FIG. 1 shows a block diagram representing the method according to the invention;

FIG. 2A shows an example of a digital document which can be analysed using the method according to the invention;

FIG. 2B shows an example of an interface of an augmented reality document which can be obtained using the method according to the invention;

FIG. 3 shows an example of an interface showing an index of elements of a document which can be patented;

FIG. 4 shows an example of an interface which shows a part of a hypertext which can be obtained using the method according to the invention.

### DETAILED DESCRIPTION

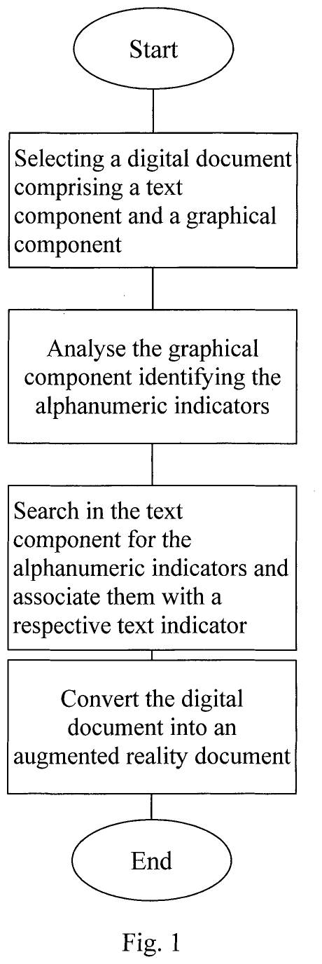

The method for the analysis of digital documents 10, of which a flow diagram is shown in FIG. 1, makes it possible to obtain and make available to a user a large range of information by the association to a portion of a graphical component 12 of the document of a variety of portions of a text component 11 containing information connected to the portion of the graphical component 12 of interest.

More specifically, the method according to the invention comprises selecting a digital document 10, which comprises a text component 11 and a graphical component 12.

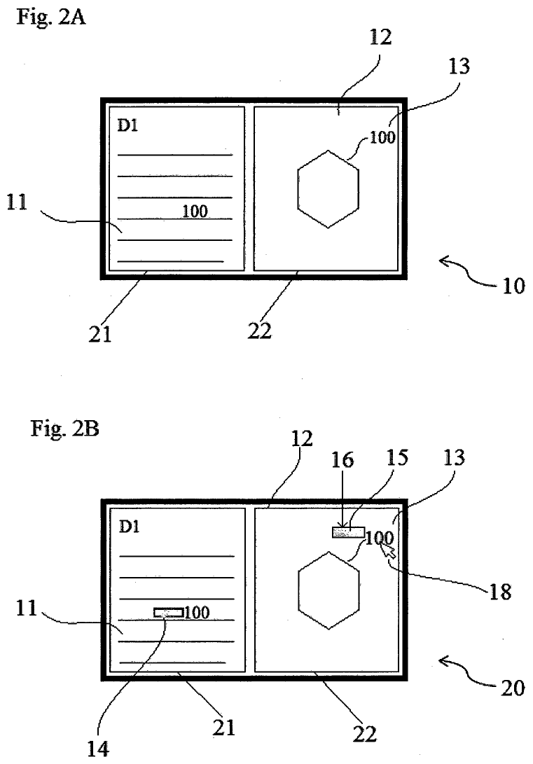

The analysis method is particularly suitable in the cases in which the digital document 10 is a patent document, such as, for example, shown in FIG. 2A, in this case, the text component 11 is represented by the description of the patent text and the graphical component 12 is represented by the drawings of the patent text.

The graphical component 12 is then analysed in such a way as to identify the alphanumeric indicators 13 which are associated with respective portions of the graphical component 12.

For example, the graphical component can contain inside it drawings and numbers which are associated with different parts of the drawings and which identify them.

Advantageously, the analysis method according to the invention is able to manage a wide variety of electronic formats in which the digital document 10 could be produced, such as, for example txt, pdf, Excel file and others.

More specifically, in order to allow a correct analysis, the method comprises a step of converting the digital document into a format suitable for being searched, preferably by means of an optical character recognition process (OCR).

The possibility of performing the analysis also on documents in a format which cannot normally be searched guarantees the possibility of selecting the digital document 10 from a wide variety of sources without having to select in advance only those in which the digital document 10 is provided in predetermined formats.

The digital document 10 may therefore be selected both by an internal source, such as an internal memory of the computer on which the method is performed, and by an external source, such as, for example, a database present on the Internet.

Once all the alphanumeric indicators 13 have been identified, the alphanumeric indicators 13 are searched for inside the text component 11 of the digital document 10 and they are associated uniquely with a text indicator 14, contained in the text component 11, representing the respective portions of the graphical component 12 to which the alphanumeric indicators 13 refer.

In other words, the alphanumeric indicators 13 perform the function of intermediaries between the various portions of the graphical component 12 and the parts of the text component 11 which describe them or, in general, contain information relative to them, allowing the first to be uniquely associated with the second.

Lastly, the digital document 10 is converted into an augmented reality document 20, shown by way of example in FIG. 2B, by displaying on the graphical component 12 of a corresponding text 15 of the text indicator 14 at the respective alphanumeric indicator 13 to which it is associated.

In use, the method according to the invention makes it possible to display a plurality of information relative to the various portions of the graphical component 12 directly on the graphical component 12.

More specifically, the corresponding text 15 may comprise a name of the respective portion of the graphical component 12, a synonym of the name of the respective portion of the graphical component 12, a description of the respective portion of the graphical component 12, a paragraph of the text component 11 which comprises the alphanumeric indicator 13 of the respective portion of the graphical component 12 or a translation of the text indicator 14 in one or more different languages.

Is also possible that one alphanumeric indicator 13 is associated inside the text component 11 of the digital document 10 to different text indicators 14.

In this situation, the corresponding text 15 may comprise and therefore show to the user all the different text indicators 14 with which a predetermined portion of the graphical component has been indicated, or select only a single text indicator 14 to be showed, selecting it on the basis of suitable criteria, such as, for example, the number of uses inside the text component 11.

All this may advantageously be made configurable by means of setting up of the system by the user.

In use, the user thus has the possibility of selecting the piece of information, or the information items, which are the most interesting for the user and useful to be displayed by inserting a suitable input, such as, for example: a click of the pointing device, a combination of keys or by using a drop-down menu.

This information can be collected directly inside the digital document 10, in particular that relative to the name of the portion of the graphical component 12, or outside the digital document 10 by searching in other digital documents 10 or in suitable websites and archives, useful in particular for searching for synonyms and translations.

Moreover, the user can to personalise the information collected by applying the analysis method since the augmented reality document can be edited for modifying the contents of the corresponding text 15.

This modification can reflect itself, or not, in a corresponding modification also of the text indicator 14 to which the corresponding text 15 refers.

If, for example, the corresponding text 15 is edited for inserting a note or a comment by the user to have a reference ready in a subsequent analysing step, or also for helping the understanding of the digital document 10 by another user, this modification can be applied and displayed only in the corresponding text 15.

Alternatively, if the corresponding text 15 is edited in order to correct errors, for example of typing or syntax, of the digital document 10, this modification can be automatically made also inside the text component 11 of the digital document 10.

Preferably, the corresponding text 15 associated with an alphanumeric indicator 13 of the graphical component 12 is displayed inside a window 16 which can open if the user acts actively on the alphanumeric indicator 13, or appear automatically when the user slides the pointer above it.

With regard to the opening of more windows 16 there are different operating configurations. According to a first configuration, the windows 16 which open when the user interacts with an alphanumeric indicator 13 disappear automatically when a different alphanumeric indicator 13 is activated or interacted with.

The term “activate” means any type of interaction of the user with a predetermined element of the digital document 10; an example of this interaction is the superposing of a pointer on the element.

In other words, the corresponding text 15 is visible only when an operator superposes, for example, a pointer on the respective alpha-numeric indicator 13 of the graphical component 12.

According to a further configuration, the various windows 16 remain, on the other hand, open until the user closes them voluntarily, but an optimisation algorithm selects their relative positions in such a way that there are not two windows 16 superposed and in fact, the various windows 16 are adequately spaced.

Lastly, especially in consideration of the case in which the number of windows 16 open is high, the user can reposition the windows 16 manually as desired.

In other words, the windows 16 are movable inside a work space defined by the augmented reality document 20.

Similarly, it is possible to display the corresponding text 15 by means of different graphics as a function of certain parameters, such as, for example, the positioning inside the text component 11 of the text indicator 14 to which they refer, for example corresponding texts 15 representing text indicators 14 which appear in different pages or paragraphs may be displayed differently.

The method according to the invention also allows a comparison to be made in which all the possible versions of the digital document 10 are compared with each other, available both in the internal memory of the computer on which the method is performed, and on the databases present on the Internet.

There is therefore a step of acquiring a plurality of different versions of the same digital document 10, the different versions may be, for example, characterised by having a different preparation and/or publication date, and performing a comparison between the respective text components 11 of all the versions available of the digital document 10 and performing the same comparison between the respective graphical components 12.

The result of this comparison, that is to say, all the differences existing between two different versions of the digital document 10, can be selectively displayed by a user in suitable windows 16 identical to those containing the corresponding text 15, or be presented in revision mode directly superposed on the digital document 10 indicated by the user as the starting point with respect to which to perform the comparison, the starting digital document could be, for example, the one having the oldest preparation date.

This functionality makes it possible to display in a simple and efficient the modifications which have been performed over time and which characterise different versions of the same digital document 10.

More specifically, in the patent sector this function makes it possible to obtain an immediate check on the modifications of the patents present in the same family of patent documents, or to display how a patent has been modified following the decision to file a divisional application or how the classification of the patent has been changed or how certain text indicators 14 have been changed during the translation into different languages.

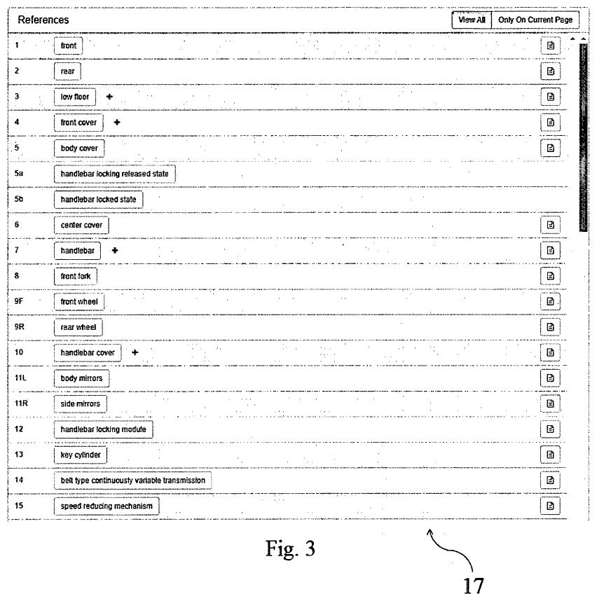

The method according to the invention further comprises a step of generating a table 17, shown in detail in FIG. 3, inside of which there is each alphanumeric indicator 13 of the graphical component 12 combined with the corresponding portion of the text component 11 associated uniquely to it.

Alternatively, it is possible to apply a filter to the table 17 in such a way that it only shows the alphanumeric indicators 13 and the corresponding text indicators 14 relative to a limited part of the graphical component 12, such as, for example, a single drawing contained therein.

In other words, the method according to the invention provides the user with a table 17 which presents the complete list of the alphanumeric indicators 13 contained inside the graphical component 12, each combined directly with the relative text indicator 14, in such a way as to provide a simple and efficient reference which makes it possible to display and identify in a complete and immediate manner all the various portions of the graphical component 12 and the associated information.

Is also possible for the user to select the type of text indicator 14, in such a way as to allow a further level of selecting the information which is displayed.

In order to further improve the legibility of the variety of information which can be obtained by the method according to the invention, there is also a step of generating a graphical interface for showing the augmented reality document 20 in such a way that the text component 11 is shown in a first window 21 whilst the graphical component 12 is shown in a second window 22.

The first and the second window 21, 22 may be placed side by side and displayed simultaneously.

According to this specific displaying method it is possible to provide a very clear display of the existing the relation between an alphanumeric indicator 13 and the respective text indicator 14, for example when a user superposes a pointer 18 on an alphanumeric indicator 13 the text indicator 14 to which it is uniquely associated is highlighted in the text component 11.

Preferably, this highlighting is obtained by colouring or underlining the text indicator 14.

In the same way, superposing a point 18 on a text indicator 14 may generate a highlighting of a corresponding alphanumeric indicator 13 inside the graphical component 12.

For example, it is possible to scroll the text component 11 of the digital document 10 in the first window 21 and, when required, activate a text indicator mentioned therein and see it highlighted in the graphical component 12 shown in second window 22.

The method according to the invention thus makes it possible to move interactively between the graphical component 12 and the text component 11 of the digital document 10.

The interactivity is also achieved by using the table 17 containing the list of all the alphanumeric indicators 13 combined with the respective text indicators 14.

For example, it is possible to interact with the table 17 in such a way that an input, such as the superposing of the pointer 18, applied to a component of the table 17, whether it is an alphanumeric indicator 13 or a text indicator 14, generates a highlighting of the component inside, respectively, the graphical component 12 and/or text component 11.

Vice versa, if an alphanumeric indicator 13 is activated in the graphical component 12, the corresponding element may be highlighted in the table 17.

In the case of a portion of graphical component 12 present in several different points of the graphical component, it is possible to display starting from the respective component in the table 17 all the parts of the graphical component 12 inside of which the portion appears.

In the same way, the user can select a portion of the text component 11 which is larger, such as, for example, a paragraph or a entire section, inside of which there are several text indicators 14.

In this case, the method comprises a step of identifying all the text indicators 14 contained in the portion of the text component 11 selected and displaying the portion of the graphical component 12, for example the single image, most pertinent with the paragraph selected.

The expression “most pertinent” means the portion of the graphical component 12 which is most significant and representative of the portion of text component 11 according to criteria which can be selected by the user, for example the one which contains inside it the greater number of text indicators 14 identified inside the portion of text component 11 selected by the user.

The advantage for the user is to be able to display the image more significant for example for a paragraph, or, if the portion is a general introduction of the contents of the digital document 10, the drawing which best summarises the contents of the digital document 10.

Advantageously, the analysis method may also be applied to a draft during preparation; in this way, by the completion in real time of the table 17 which associates to each portion of the graphical component 12 a reference alphanumeric indicator 13 and a text indicator 14 of the text component 11 an immediate check is obtained of the unique associations between elements of the two components 11, 12.

The user can thus check whether inconsistencies appear, such as, for example, the same text indicator 14 referred by error to two different and distinct alphanumeric indicators 13, or vice versa, and correct the draft accordingly.

Is also possible to implement an automatic corrector which signals these inconsistencies, as well as a standardisation function which, once activated, shows to the user all the different expressions referred to the same portion of the graphical component 12 and automatically or when instructed by the user replaces in the digital document 10 a single standard version in place of the various variants.

In other words, the method comprises an automatic correction step wherein an audio-visual signal is activated if the same text indicator 14 is associated with more than one alphanumeric indicator 13.

In the same way, the audio-visual signal is activated when an alphanumeric indicator 13 is associated with a plurality of text indicators which do not represent the same element.

Obviously, any occurrence is not signalled as an error wherein the same alphanumeric indicator 13 is associated with a plurality of text indicators 14 of different type (name, synonym, description, translation or others) but all referred to and representing the same element and/or technical function.

More specifically, it is possible to decide that the correction step is performed by controlling the uniqueness of the combinations only on one information category which is available in the text indicators; preferably, the information is the name of the portion of the graphical component 12 to which are associated the respective alphanumeric indicators 13 and text indicators 14, in such a way that the audio-visual signal is activated if the same alphanumeric indicator 13 corresponds to different names.

More specifically, the audio-visual signal may be, for example, an acoustic signal, or a highlighting, by means of colouring or underlining, of the elements having the inconsistency or a suitable combination of both.

The final and correct table 17 which associates alphanumeric indicators 13 and text indicators 14 may be saved and shared with third parties as a legend of the graphical component 12 of the digital document 10.

It is also possible to determine by the analysis of the text component a series of relations between elements described in the text component 11 and/or shown in the graphical component 12, such as, for example, relations of vicinity, connection or of action of one element relative to another.

The term “vicinity relations” means that two elements are positioned adjacent to each other, preferably in reciprocal contact with each other.

The term “connection relation” is used to mean that two or more elements are connected, preferably connected to each other.

The term “action relation” means that a first element is configured to perform an action on a second element.

These relations can be displayed in various ways on the graphical component 12, for example by means of connectors or by means of connectors and tags which show the above-mentioned relation between the alphanumeric indicators 13 of the graphical component or by suitable relational graphics and/or tables 17a to be displayed separately. The method according to the invention therefore comprises a step of generating a relational table 17a comprising each alphanumeric indicator 13 and/or text indicator 14 associated with each alphanumeric indicator 13 and/or text indicator 14 with which it shares a relationship.

The indicators of the presence of a relation can be activated on command, for example by clicking on an element one can choose to display all the components which interact with it.

The user may the leave activated the connections considered significant, modify the existing associations or create new associations to improve the information content.

The relation between two elements may be highlighted with distinctive graphic signs for each type of interaction, or by presenting windows 16 containing portions of the text component 11 representing both the elements, or with a synthetic and standardised reprocessing of the portions.

More specifically, the relations which have a direction (a first element performs an action on a second element) have suitable graphical elements which make it possible to visually highlight the direction of the relation, the graphical elements may be, for example, arrows which extend from the first element and point to the second element, both inside of the graphical component 12 and, if necessary, inside the table 17.

Moreover, especially if the digital document 10 to be analysed is a patent document, it may be particularly useful to have information available relative to the existing relations between various elements described inside it and on the presence of some limiting expressions which give information relating to the number or to the special positioning of some elements such as, for example: at least, a plurality, solely, only, included between.

These limiting expressions can be integrated inside the corresponding text 15 and displayed in the augmented reality document 20.

In the same way, it is possible to display the corresponding text 16 by means of different graphics as a function of certain parameters, such as, for example, the portion of the text component 11 inside of which there is the text indicator 14 to which the corresponding text 15 refers. For example, it is possible to display in a different manner the corresponding text 16 generated by text indicators present either only in the description or only in the claims or in both.

The invention also relates to an augmented reality document 20 which can be obtained by a method as described above.

The augmented reality document 20 comprises a graphical component 12 which has at least one alphanumeric indicator 13 and is configured for displaying at least one text indicator 14 of a digital document 10.

The text indicator 14 represents at least an alphanumeric indicator 13 to which is associated, since it contains information connected to it and is preferably displayed at it, still more preferably inside a window 16 which may be moved inside the space defined by the augmented reality document.

The invention also relates to a hypertext 30 which comprises a plurality of augmented reality documents 20 obtained by means of the method described above, wherein the alphanumeric indicator 13 of an augmented reality document 20 may be associated with a text indicator 14 of a different augmented realty document 20 of the hypertext 30.

In other words, the hypertext 30 comprises a plurality of augmented reality documents 20 which are to form a database inside of which it is possible to search for and obtain information relative to elements of the graphical component 12 of each augmented reality document 20 which are functionally similar, in particular which can be associated with the same text indicator.

However, it is possible that the same elements are indicated inside different documents by text indicators 14 which are different to each other; to overcome this drawback the search inside the hypertext 30 occurs not only by searching for the perfect identity between text indicators 14, but also with the aid, for example, of suitable lists, for example of synonyms, similarities or periphrases, which make it possible to identify, given a search inside the hypertext 30, all the elements which satisfy the search criteria, irrespective of the specific text indicator 14 with which they have been indicated in the single digital document 10.

It is possible, for example, to activate, both acting on an alphanumeric indicator 13 an on a text indicator 14, a search of all the augmented reality documents 20 which contain a predetermined graphical portion to which the indicators 13, 14 refer.

Consequently, the graphical components 12 of the various augmented reality documents 20 containing the graphical portion in question are shown in a suitable composition alongside the starting graphical component 12.

In order to increase the precision of the search it is possible to apply filters relative to the type of elements to be searched for, the type of view of the graphical component 13 to be shown or other criteria suitable for limiting the field of search inside the hypertext 30.

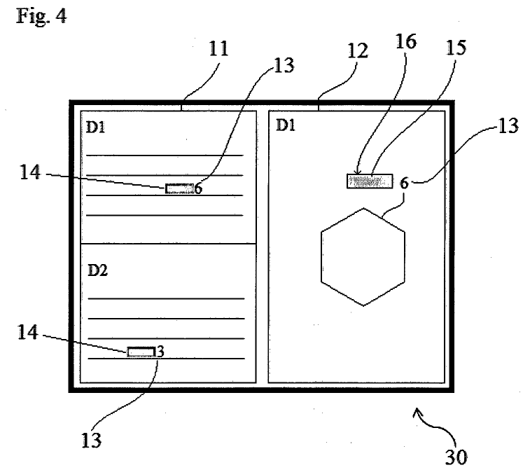

More specifically, as shown in FIG. 4, given two or more augmented reality documents 20 of the hypertext 30 for which a comparative inspection is to be made it is possible to show the graphical components 12 of each augmented reality document 20 simultaneously.

The selection of the portion of the graphical component 12 to be shown between the various ones may be made directly by the user or it may be performed by a series of algorithms/filters, such as, for example, with the possibility of highlighting only the portions of the graphical component 12 relative to predetermined portions of the text component 11 suitably selected, or only those relative to portions which have a similar content.

The comparison process can be even activated starting from a portion of the text component 11 of an augmented reality document 20 thereby searching inside the hypertext 30 all the augmented reality documents 20 which contain graphical components 12 having a graphical portion corresponding to the portion of the text component 11 of interest.

It is evident that the same elements contained in the text components 11 of different documents can be associated with different alphanumeric indicators 13.

For this reason, it is also possible to provide an equivalence matrix of the hypertext 30 which associates with each alphanumeric indicator 13 each text indicator 14 with which it is represented in the various documents which make up the hypertext 30, the equivalence matrix can be modified by the user if the user detects the presence of two similar elements which have not been detected automatically in the conversion of the digital documents 10 into components of hypertext 30.

In other words, the user can manually associate a numeral indicator 13 to a predetermined text indicator 14; the forced association, as well as influencing directly the hypertext 30, can be further stored in a database inside the computer performing the method in such a way that it can be automatically acknowledged in a subsequent use of the method and, if necessary, shared also with other users.

Another aspect of the invention relates to a computer program configured, when in use, to perform the steps of the method described above.

Moreover, the invention relates to a system for analysing digital documents 10 which comprises a computer and a processing unit.

The processing unit is configured to perform the following steps:
selecting a digital document 10 comprising a text component 11 and a graphical component 12;
analysing the graphical component 12 identifying alphanumeric indicators 13 associated with respective portions of the graphical component 12;
searching inside the text component 11 of the digital document 10 for the alphanumeric indicators 13 identified inside the graphical component 12 and associating them uniquely with a text indicator 14 of the text component 11 representing the respective portions of the graphical component 12;
converting the digital document 10 into an augmented reality document 20 configured for displaying on the graphical component 12 a corresponding text 15 of the text indicator 14 at the respective alphanumeric indicator 13 associated with the text indicator 14.

More specifically, the digital document 10 may be selected and acquired by the processing unit from different sources: it is possible to request the document to be displayed simply by means of an identification code and the document is acquired on the spot from an internal source, an internal memory of the computer, or externally, such as a database present, for example, on the Internet.

The selection of the digital documents 10 to be analysed can be made by the user both from the inside of a suitable interface of the computer program and from the interface of a third party document control software: in this second case, the document of interest can be selected from the starting program in various ways: actuating a pointer, suitable combination of keys or other method and a suitable software routine will open the document selected in the computer program according to the invention.

Since several versions of the document may exist, it is also possible to set up the version which the user wants to select.

It is also possible to save only a part of the information contained in the augmented reality document 20 in special use configurations storing the augmented reality document 20 in the computer.

For example, it is possible to store a predetermined positioning and/or content of the corresponding text 15; or it is possible to save individually the table 17 of the digital document 10.

It is possible to save/print/share both the individual graphical components 12 of a single digital document 10 and groups of graphical components 12 coming from different digital documents 10.

Advantageously, the invention also provides a method for the analysis of digital documents 10, in particular patent documents, which makes it possible to provide a large range of different information in a direct and immediate manner, without a user having to continuously search for the information by means of a laborious comparison between the graphical component 12 and the text 11 of the digital document 10.

Moreover, the method according to the invention allows the user to have access in a dynamic and selective manner to a plurality of information which can come from different sources, even outside the digital document 10, but in any case useful for improving the understanding.

In the same way, the possibility of performing searches between several digital documents 10 and performing comparisons between their components, graphic 12 and/or text 11, provides an instrument which is extremely efficient to search for information inside database and archives.

1. A method for analysing documents which can be implemented by a computer comprising the steps of:
selecting a digital document (10) comprising a text component (11) and a graphical component (12);
analysing the graphical component (12) identifying alphanumeric indicators associated with respective portions of the graphical component (12);
searching inside the text component (11) of the digital document (10) for the alphanumeric indicators (13) identified inside the graphical component (12) and associating them uniquely with a text indicator (14) of the text component (11) representing the respective portions of the graphical component (12);
converting the digital document (10) into an augmented reality document (20) at least by displaying on the graphical component (12) a corresponding text (15) of the text indicator (14), at the respective alphanumeric indicator (13) associated with the text indicator (14);
characterised in that the augmented reality document (20) can be edited for modifying a content of the corresponding text (15) and the modification of the content of the corresponding text (15) generates an identical modification of the text indicator (14) associated with it and vice versa.

2. The method according to claim 1, wherein the corresponding text (15) comprises at least one from: a name of the respective portion of the graphical component (12), a synonym of the name of the respective portion of the graphical component (12), a description of the respective portion of the graphical component (12), a paragraph of the text component (11) comprising the alphanumeric indicator (13) of the respective portion of the graphical component (12), a translation of the text indicator (14), the corresponding text (15) can further comprise a limiting expression, this limiting expression comprising for example: at least, a plurality, solely, only, included between.

3. The method according to claim 1, wherein the corresponding text (15) comprises a plurality of separate information selectively viewed as a function of an input which can be entered by a user.

4. The method according to claim 1, wherein the corresponding text (15) is visible only when an operator superposes a pointer (18) on the respective alpha-numeric indicator (13) of the graphical component (12).

5. The method according to claim 1, wherein the corresponding text (15) is contained inside a window (16) which is movable inside a work space defined by the augmented reality document (20).

6. The method according to claim 1, wherein the corresponding text (15) is shown differently, for example coloured or underlined, as a function of the text component portion (11) inside of which is contained the text indicator (14) which the corresponding text (15) represents.

7. The method according to claim 1, comprising the following steps:
acquiring a plurality of different versions of the digital document (10);
performing a comparison between the respective text components (11) of all the versions acquired of the same digital document (10) identifying the differences present between the various versions;
performing a comparison between the respective graphical components (12) of all the versions acquired of the same digital document (10) identifying the differences present between the various versions;
selectively displaying inside the windows (16) the differences present between the versions acquired of the same digital document (10).

8. The method according to claim 1, comprising a step of generating a table (17) comprising each alphanumeric indicator (13) of the graphical component (12) combined with the corresponding text indicator (14) uniquely associated with the alphanumeric indicator (13).

9. The method according to claim 4, wherein when an operator superposes a pointer (18) on an alphanumeric indicator (13) the text indicator (14) which is uniquely associated with the alphanumeric indicator (13) is highlighted in the text component (11) and/or in the table (17), preferably coloured or underlined or, vice versa, when an operator superposes a pointer (18) on a text indicator (14) the alphanumeric indicator (13) which is uniquely associated with the text indicator (14) is highlighted in the graphical component (12) and/or in the table (17), preferably coloured or underlined.

10. The method according to claim 1 for displaying by means of connectors or a table the alphanumeric indicators (13) of the graphical component or the text indicators (14) associated with each alphanumeric indicator (13) which share a relationship, the relationship comprising: relations of vicinity, connection, action of a alphanumeric indicator (13) of the graphical component (12) with respect to another alphanumeric indicator (13) of the graphical component (12).

11. The method according to claim 1, comprising steps of:
selecting a portion of the text component (11), such as, for example, a paragraph or a cross section, inside of which there is at least a text indicator (14);
identifying all the text indicators (14) contained in the portion of the text component (11) selected;
selecting and displaying amongst all the portions of the graphical component (12) the portion of graphical component (12) more pertinent with the portion of text component (11) according to criteria which can be selected by the user, for example the one which contains inside it the greater number of text indicators (14) identified inside the portion of text component (11) selected by the user.

12. The method according to claim 1, also comprising an automatic correction step wherein an audio-visual signal is activated if the same text indicator (14) is associated with more than one alphanumeric indicator (13).

13. An augmented reality document (20), which can be obtained by means of a method according to claim 1, comprising a graphical component (12) having at least one alphanumeric indicator (13) and configured for displaying at least one text indicator (14) of a digital document (10), the text indicator (14) representing the at least one alphanumeric indicator (13).

14. A hypertext (30) comprising a plurality of augmented reality documents (20) according to claim 13, wherein the alphanumeric indicator (13) of an augmented reality document (20) may be associated with a text indicator (14) of at least a different augmented realty document (20) of the hypertext (30).

15. The hypertext (30) according to claim 14, comprising a table of the hypertext (30) comprising each text indicator (14) coupled to each alphanumeric indicator (13) to which the text indicator (14) is associated in the plurality of augmented reality documents (20) of the hypertext (30), the text indicator (14) being associated with at least one alphanumeric indicator (13) of an augmented reality document (20) of the hypertext (30).

16. The hypertext according to claim 14, comprising an equivalence matrix of the hypertext (30) configured to associate to each alphanumeric indicator (13) each text indicator (14) to which it is associated in the plurality of digital documents (10) which make up the hypertext (30).

17. The hypertext according to claim 16 wherein the equivalence matrix can be edited by a user to associate a numeral indicator (13) to a predetermined text indicator (14).
